(19) United States
(12) Patent Application Publication
(10) Pub. No.: US 2026/0204960 A1
(43) Pub. Date: Jul. 16, 2026

(54) DUAL-ROTOR MOTOR STRUCTURE

(71) Applicant: INDUSTRIAL TECHNOLOGY RESEARCH INSTITUTE, Hsinchu (TW)

(72) Inventors: Yu-Hsun WU, Taipei City (TW); Chun-Chieh CHANG, Taipei City (TW); Ya-Ling CHANG, Zhubei City (TW); Jia-Yao JHANG, Taoyuan City (TW)

(73) Assignee: INDUSTRIAL TECHNOLOGY RESEARCH INSTITUTE, Hsinchu (TW)

(21) Appl. No.: 19/358,962

(22) Filed: Oct. 15, 2025

(30) Foreign Application Priority Data
Jan. 15, 2025 (TW) 114101639

(51) Int. Cl. H02K 1/14; H02K 1/278; H02K 1/2791; H02K 16/02

(52) U.S. Cl. CPC H02K 1/148; H02K 1/278; H02K 1/2791; H02K 16/02

(57) ABSTRACT

A dual-rotor motor structure is provided in the present invention. The dual-rotor motor structure comprises a first rotor, a second rotor and a plurality of combined stators. The second rotor is radially disposed to the first rotor. The combined stators are radially disposed between the first rotor and the second rotor, and the combined stators are connected in pairs along a tangential direction. Each of the combined stators includes an inner stator, a middle stator, and an outer stator. The middle stator is connected between the inner stator and the outer stator, and the middle stator is connected between another two adjacent middle stators.

This application claims the benefits of the Taiwan application Serial No. 114101639 filed on January 15, 2025, the disclosure of which is incorporated by reference herein in its entirety.

### TECHNICAL FIELD

The present invention relates to a dual-rotor motor structure, and in particular relates to a dual-rotor motor structure having a plurality of combined stators.

### BACKGROUND

The demand for permanent magnet motors with high power density gradually increases in automotive power systems, high-end grinding machine tools and unmanned aerial vehicle power systems. All of these require smaller volume and greater output power. The most direct approach to address this demand is fundamentally to increase the electromagnetic torque, which however means stronger magnets or higher current must be adopted. That is, these methods all cause excessive loss and increase motor volume. In view of this, how to provide a solution that improves the total output torque of the motor and increases the power density of the motor without increasing the motor volume has become the direction pursued by practitioners in this field.

### SUMMARY

According to an aspect of the present invention, a dual-rotor motor structure is provided. The dual-rotor motor structure comprises a first rotor, a second rotor and a plurality of combined stators. The second rotor is radially disposed to the first rotor. The combined stators are radially disposed between the first rotor and the second rotor, and the combined stators are connected in pairs along a tangential direction. Each of the combined stators includes an inner stator, a middle stator, and an outer stator. The middle stator is connected between the inner stator and the outer stator, and the middle stator is connected between another two adjacent middle stators.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 illustrates a plan view of a dual-rotor motor structure according to an embodiment of the present invention.

FIG. 2 illustrates a plan view of a dual-rotor motor structure according to another embodiment of the present invention.

FIG. 3A illustrates an exploded view of combined stators included in the dual-rotor motor structure.

FIGS. 3B and 3C illustrate perspective views of the combined stators included in the dual-rotor motor structure.

FIG. 3D illustrates another exploded view of the combined stators included in the dual-rotor motor structure.

### DETAILED DESCRIPTION

Detailed descriptions of the embodiments of the specification are disclosed below with reference to the accompanying drawings. Apart from the detailed descriptions provided, any embodiments in which the present invention can be used as well as any substitutions, modifications or equivalent changes of the said embodiments are within the scope of the disclosure, and the descriptions and definitions in the claims shall prevail. In the following detailed description, for purposes of explanation, numerous specific details are set forth in order to provide a thorough understanding of the disclosed embodiments. It will be apparent, however, that one or more embodiments may be practiced without these specific details. Additionally, well-known common steps or components are not described in detail to avoid unnecessarily limiting the present invention. The same or similar elements in the figures are represented by the same or similar reference sign.

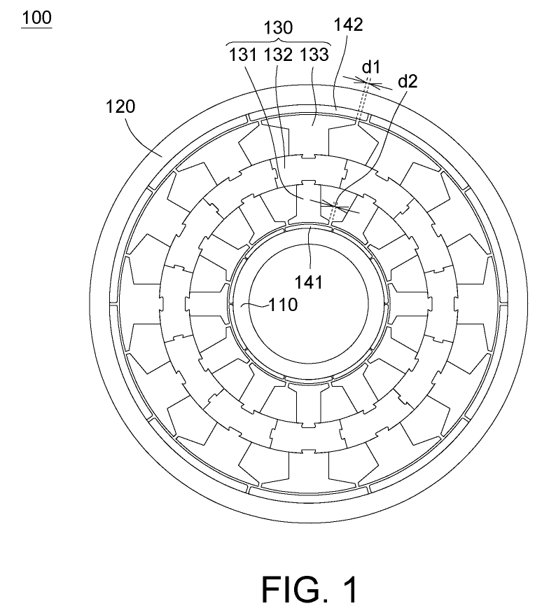

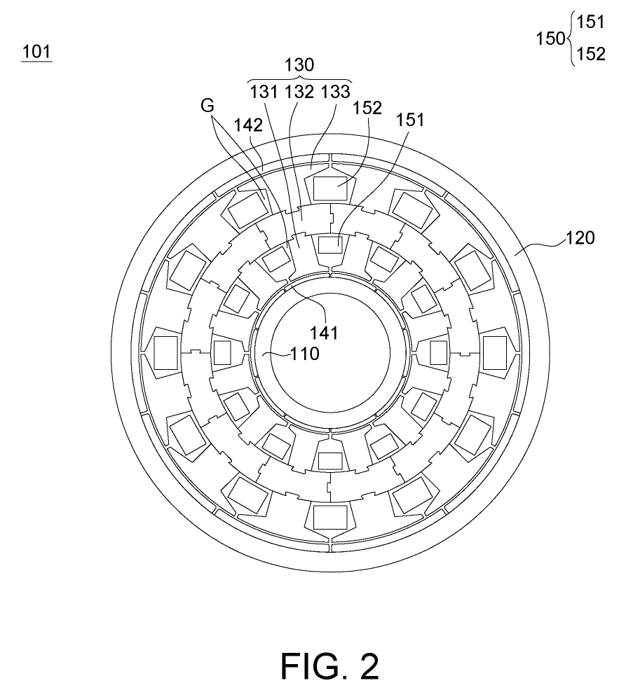

Please refer to FIGS. 1 and FIG. 2. FIG. 1 illustrates a plan view of a dual-rotor motor structure 100 according to an embodiment of the present invention. FIG. 2 illustrates a plan view of a dual-rotor motor structure 101 according to another embodiment of the present invention.

As shown in FIG. 1, the dual-rotor motor structure 100 may comprise a first rotor 110, a second rotor 120, a plurality of combined stators 130, a plurality of first magnetic components 141, and a plurality of second magnetic components 142. The first rotor 110 and the second rotor 120 are radially disposed to each other. The first rotor 110 is disposed at the innermost radial side of the dual-rotor motor structure 100 and serves as an inner rotor. The second rotor 120 is disposed at the outermost radial side of the dual-rotor motor structure 100 and serves as an outer rotor. A circumference of the second rotor 120 is greater than a circumference of the first rotor 110.

The combined stators 130 are radially and equally angularly spaced in an annular space between the first rotor 110 and the second rotor 120. Specifically, the combined stators 130 are also radially located between the first magnetic components 141 and the second magnetic components 142. In this embodiment, the dual-rotor motor structure 100 comprises twelve combined stators 130 by way of example. The combined stators 130 are connected in pairs along a tangential direction. During operation of the dual-rotor motor structure 100, the first rotor 110 and the second rotor 120 rotate, while all the combined stators 130 remain stationary.

The first magnetic components 141 and the second magnetic components 142 are, for example, permanent magnets. In this embodiment, the dual-rotor motor structure 100 comprises ten first magnetic components 141 and ten second magnetic components 142, but is not limited thereto. The first magnetic components 141 are fixed to an outer wall of the first rotor 110. The second magnetic components 142 are fixed to an inner wall of the second rotor 120, wherein the fixing means may be adhesion. That is, the first magnetic components 141 rotate along with the first rotor 110, and the second magnetic components 142 rotate along with the second rotor 120. The first magnetic components 141 are disposed on the outer wall of the first rotor 110 with alternating N poles and S poles. The second magnetic components 142 are disposed on the inner wall of the second rotor 120 with alternating N poles and S poles. When the number of second magnetic components 142 is the same as the number of first magnetic components 141, since the second magnetic components 142 are radially disposed farther outward than the first magnetic components 141, an arc length of a single second magnetic component 142 is greater than an arc length of a single first magnetic component 141.

As shown in FIG. 2, the configuration of the dual-rotor motor structure 101 is substantially the same as that of the dual-rotor motor structure 100, and may include the aforementioned first rotor 110, second rotor 120, a plurality of combined stators 130, a plurality of first magnetic components 141 and a plurality of second magnetic components 142. The dual-rotor motor structure 101 may further include a plurality of conductive components 150. The conductive components 150 may be, for example, copper wire coils. The conductive components 150 are disposed in gap regions G between the plurality of combined stators 130. In this embodiment, the conductive components 150 may include inner conductors 151 and outer conductors 152. A size of the inner conductor 151 is smaller than a size of the outer conductor 152, in response to the condition that an accommodating range of the gap region G adjacent to the first rotor 110 is smaller than an accommodating range of the gap region G adjacent to the second rotor 120.

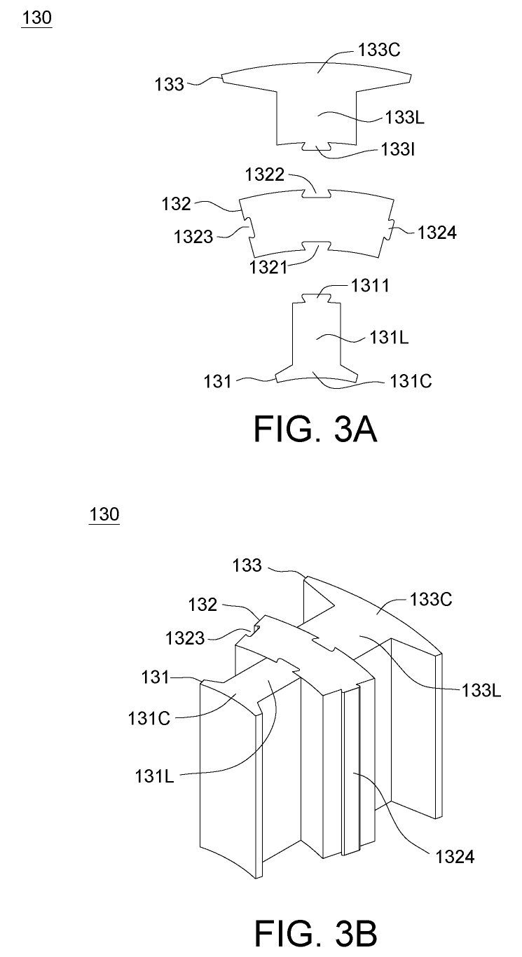

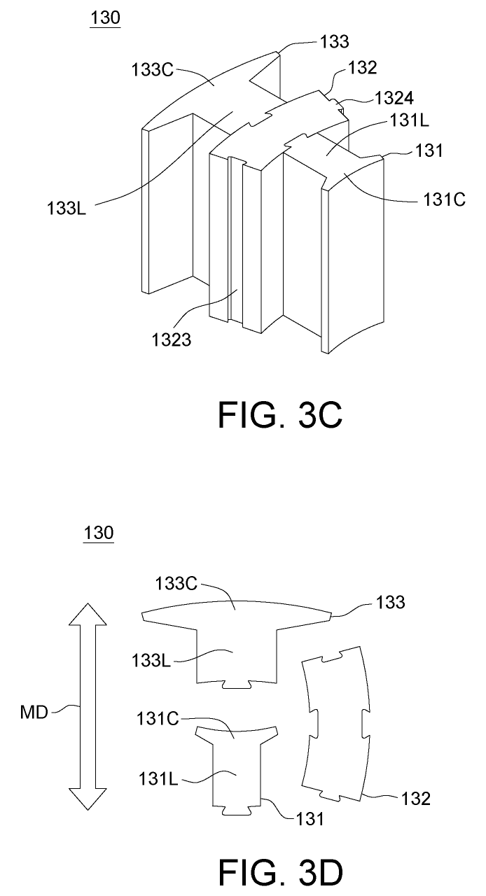

Further, please also refer to FIGS. 3A to 3D. FIGS. 3A and 3D illustrate exploded views of a single combined stator 130. FIGS. 3B and 3C illustrate perspective views of a single combined stator 130.

Each of the combined stators 130 may include an inner stator 131, a middle stator 132 and an outer stator 133. The middle stator 132 is connected between the inner stator 131 and the outer stator 133, and is further connected between another two adjacent middle stators 132. In detail, the inner stator 131, the middle stator 132 and the outer stator 133 are radially connected in the dual-rotor motor structure 100/101. As shown in FIG. 1, the inner stator 131 is radially adjacent to the first rotor 110, and the outer stator 133 is radially adjacent to the second rotor 120. The inner stator 131 has an inner latch 1311. The outer stator 133 has an outer latch 1331. The middle stator 132 has an inner slot 1321 and an outer slot 1322 that are disposed oppositely, and a side slot 1323 and a side latch 1324 that are disposed oppositely. The inner stator 131 is fixed to the middle stator 132 by engaging the inner latch 1311 into the inner slot 1321. The outer stator 133 is fixed to the middle stator 132 by engaging the outer latch 1331 into the outer slot 1322. The adjacent middle stators 132 are connected in pairs along a tangential direction, so that the plurality of combined stators 130 can be fixed together to form an annular assembly. Specifically, two adjacent combined stators 130 are connected in pairs by engaging the side latch 1324 into the side slot 1323.

The inner stator 131 may include an inner arc portion 131C and an outer straight portion 131L. The inner arc portion 131C of the inner stator 131 may be radially adjacent to the first rotor 110. The outer straight portion 131L of the inner stator 131 may connect to the middle stator 132, and the inner latch 1311 is formed on the outer straight portion 131L. The outer stator 133 may include an outer arc portion 133C and an inner straight portion 133L. The outer arc portion 133C of the outer stator 133 may be radially adjacent to the second rotor 120. The inner straight portion 133L of the outer stator 133 may connect to the middle stator 132, and the outer latch 1331 is formed on the inner straight portion 133L. As shown in FIG. 3A, an arc length of the outer arc portion 133C of the outer stator 133 is greater than an arc length of the inner arc portion 131C of the inner stator 131; a width of the inner straight portion 133L of the outer stator 133 is greater than a width of the outer straight portion 131L of the inner stator 131; and a width of the inner stator 131 is greater than the width of the inner straight portion 133L of the outer stator 133 and the width of the outer straight portion 131L of the inner stator 131. As shown in FIGS. 3B and 3C, a thickness of the inner stator 131, a thickness of the middle stator 132 and a thickness of the outer stator 133 are identical, but not limited thereto. As shown in FIGS. 3B and 3C, the side slot 1323 and the side latch 1324 of the middle stator 132 are formed to extend along a thickness direction. Likewise, the inner slot 1321 and the outer slot 1322 of the middle stator 132 are also formed to extend along the thickness direction; the inner latch 1311 of the inner stator 131 is also formed to extend along the thickness direction; and the outer latch 1331 of the outer stator 133 is also formed to extend along the thickness direction.

By combining each of the combined stators 130 with the inner stator 131, the middle stator 132, and the outer stator 133, an advantage is that winding of the motor structure is facilitated. Specifically, the middle stators 132 of each of the combined stators 130 can be first assembled and connected, and then windings can be wound around the inner stators 131 and the outer stators 133 of each of the combined stators 130. After winding, the inner stators 131 and the outer stators 133 are assembled and connected to the corresponding middle stators 132. In other words, the combined stator 130 of the present invention allows the stators that require winding to be separated, wound, and then assembled, which is more convenient than winding an integrated stator.

In addition, the combined stator 130 of the present invention has other advantages. As mentioned above, since the stators requiring winding can be separated, wound, and then assembled, as shown in FIG. 1, a distance d1 between two adjacent outer stators 133 can be designed to be smaller than a thickness of the winding wire, and a distance d2 between two adjacent inner stators 131 can also be designed to be smaller than a thickness of the winding wire. In contrast, in the case of an integrated stator, winding must necessarily pass through the gaps between the stators, and then winding can begin. Therefore, the gaps between the stators cannot be designed to be smaller than the thickness of the winding wire; otherwise, the winding operation cannot be performed. In comparison, the combined stator 130 of the present invention can make more effective use of the space between the two rotors.

Regarding the material selection, the inner stator 131, the middle stator 132 and the outer stator 133 of the combined stator 130 are each formed by laminating a plurality of directional silicon steel sheets. That is, as shown in FIG. 3D, magnetic flux lines of the inner stator 131, the middle stator 132, and the outer stator 133 of the combined stator 130 can be oriented in a single direction MD. Accordingly, after assembly of the combined stator 130, the magnetic flux directions of the inner stator 131 and the outer stator 133 can be substantially parallel or identical, while the magnetic flux direction of the middle stator 132 can be substantially perpendicular to the magnetic flux directions of the inner stator 131 and the outer stator 133. According to practical simulation tests (e.g., finite element analysis), under the condition that other configurations of the dual-rotor motor structure are the same, comparison between an integrated stator made of non-oriented silicon steel sheets and a combined stator made of oriented silicon steel sheets shows that, under the same current, torque of the motor using the latter is improved by about 9.2% compared with the former. This means that under the same rotational speed, the power density of the motor can also be increased by 9.2%.

As described above, the present invention provides a dual-rotor motor structure in which the combined stator is formed by combining the inner stator, the middle stator and the outer stator and the combined stator is disposed between the first rotor and the second rotor. This configuration can effectively utilize the inner space of the dual-rotor motor and reduce winding difficulty, thereby improving the total output torque of the motor and increasing the motor power density. In addition, the combined stator can be made of oriented silicon steel sheets so that the magnetic field directions are consistent, which can be applied to a closed magnetic loop of the motor to provide higher saturation magnetic flux density, thereby achieving the effect of reducing the motor volume.

It will be apparent to those skilled in the art that various modifications and variations may be made to the disclosed embodiments. It is intended that the specification and examples be considered as exemplars only, with a true scope of the disclosure being indicated by the following claims and their equivalents.

What is claimed is:

1. A dual-rotor motor structure, comprising:
a first rotor;
a second rotor radially disposed to the first rotor; and
a plurality of combined stators radially disposed between the first rotor and the second rotor, wherein the combined stators are connected in pairs along a tangential direction;
wherein each of the combined stators includes an inner stator, a middle stator and an outer stator, the middle stator is connected between the inner stator and the outer stator, and the middle stator is connected between another two adjacent middle stators.

2. The dual-rotor motor structure according to claim 1, wherein the inner stators are radially adjacent to the first rotor, and the outer stators are radially adjacent to the second rotor.

3. The dual-rotor motor structure according to claim 1, wherein the middle stators are mutually connected in pairs along the tangential direction.

4. The dual-rotor motor structure according to claim 1, wherein the middle stator has an inner slot, the inner stator has an inner latch, and the inner stator is fixed to the middle stator by engaging the inner latch into the inner slot.

5. The dual-rotor motor structure according to claim 1, wherein the middle stator has an outer slot, the outer stator has an outer latch, and the outer stator is fixed to the middle stator by engaging the outer latch into the outer slot.

6. The dual-rotor motor structure according to claim 1, wherein the middle stator has a side slot and a side latch disposed oppositely, and two adjacent combined stators are mutually connected in pairs by engaging the side latch into the side slot.

7. The dual-rotor motor structure according to claim 1, wherein the inner stator includes an inner arc portion and an outer straight portion, and the inner arc portion is radially adjacent to the first rotor, and the outer straight portion is connected to the middle stator.

8. The dual-rotor motor structure according to claim 7, wherein the outer stator includes an outer arc portion and an inner straight portion, and the outer arc portion is radially adjacent to the second rotor, and the inner straight portion is connected to the middle stator.

9. The dual-rotor motor structure according to claim 8, wherein an arc length of the outer arc portion is greater than an arc length of the inner arc portion.

10. The dual-rotor motor structure according to claim 8, wherein a width of the inner straight portion is greater than a width of the outer straight portion.

11. The dual-rotor motor structure according to claim 8, wherein a width of the inner stator is greater than the width of the inner straight portion and the width of the outer straight portion.

12. The dual-rotor motor structure according to claim 1, wherein a thickness of the inner stator, a thickness of the middle stator and a thickness of the outer stator are identical.

13. The dual-rotor motor structure according to claim 1, wherein each of the combined stators is formed by stacking a plurality of directional silicon steel sheets.

14. The dual-rotor motor structure according to claim 1, further comprising:
a plurality of first magnetic components fixed to an outer wall of the first rotor; and
a plurality of second magnetic components fixed to an inner wall of the second rotor.

15. The dual-rotor motor structure according to claim 1, further comprising:
a plurality of conductive components disposed in gap regions between the plurality of combined stators.
